(19) United States
(12) Patent Application Publication
(10) Pub. No.: US 2009/0063671 A1
(43) Pub. Date: Mar. 5, 2009

(54) METHOD, DEVICE, SOFTWARE FOR DETERMINING A NEED

(75) Inventors: Jarno Guidi, Bologna (IT); Javier Espina, Aachen (DE); Maarten Peter Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/719,012

(22) PCT Filed: Nov. 11, 2005
(86) PCT No.: PCT/IB05/53726

§ 371 Date: May 10, 2007

(30) Foreign Application Priority Data
Nov. 17, 2004 (EP) 04105828.0

(51) Int. Cl. G06F 15/173

(52) U.S. Cl. 709/224

(57) ABSTRACT

The present invention relates to a method, a client device (CL) and a computer program product for determining the need for requesting network configuration information from a network. The client device includes memories (M₁, M₂) comprising network identifying data (NI) and corresponding configuration data, and a control unit (CO). The control unit orders the connection of the client device to a network, compares first network identifying data associated with said network with second locally stored network identifying data from a memory and uses locally stored network configuration data associated with said second network identifying data for obtaining services if said first network identifying data and said second network identifying data correspond to each other. Because of this the number of searches in a network is limited in case the client device has previous knowledge about the network.

The present invention generally relates to the field of computer networks and more particularly to a method, a client device and a computer program product for determining the need for requesting network configuration data from a network.

In the field of peer-to-peer networking the connectivity standard used is often the UPnP™ standard. This standard defines entities such as UPnP™ control points and UPnP™ devices. A UPnP™ device is here a logical entity that has a set of services it offers to different elements of the network and a UPnP™ control point is a logical entity that tries to get access to a UPnP™ device. A physical device can contain any number of UPnP™ devices and UPnP™ control points. A physical device comprising a UPnP™ control point is termed a client device, while a physical device comprises a UPnP™ device.

Before being able to use devices and services a client device has to find out what devices and services are available in a network. Client devices can search for devices and services by sending out a multicast search request with a specific query. Devices in the network respond to that search if their capabilities match the query. One client device can send out such a search and get a response from all the devices in the network. After that the client device can periodically recheck and/or automatically be notified of newly arrived devices and/or services or changes to existing devices and services.

There is furthermore a trend towards providing mobile devices that communicate with wireless networks. It is then possible that a client device gets moved from one network to another, like for instance if the user of the client device moves from his home to his work via for instance a public traffic system. A client device can then be visiting different networks regularly. The networks that the client device moves between are then in many instances networks that the client device knows about and is familiar with.

If the above described search was made every time a client device was moved between different known networks, this would lead to unnecessary searches being made regarding known devices in networks. This unnecessary searching would then occupy a lot of the bandwidth of the network. This unnecessary searching would also lead to a significant delay before the services of devices can be used.

Document U.S. Pat. No. 6,014,667 describes a caching system that can detect whether a piece of information is cache enabled. If the information is cache enabled the system can use this cached information. The cached information can be stored at arbitrary locations because location information is stored together with the identity of the information. Cached information is then invalidated based on detection of change requests in the information.

Hence there is a need for limiting the amount of traffic when a client device visits several different networks.

It is an object of the present invention to provide a network identifying scheme.

According to a first aspect of the present invention, this object is achieved by a method of determining the need for requesting network configuration data from a network comprising the steps of:

connecting a client device to a network,

comparing first network identifying data associated with said network with second locally stored network identifying data, and

using locally stored network configuration data associated with said second network identifying data for obtaining services if said first network identifying data and said second network identifying data at least partially correspond to each other.

According to a second aspect of the present invention, this object is also achieved by a client device for determining the need for requesting network configuration data from a network and comprising:

at least one memory comprising network identifying data and corresponding configuration data, and

a control unit arranged to:
at least order the connection of said client device to a network,
compare first network identifying data associated with said network with second locally stored network identifying data from said memory, and
use locally stored network configuration data associated with said second network identifying data for obtaining services if said first network identifying data and said second network identifying data at least partially correspond to each other.

According to a third aspect of the present invention, this object is also achieved by a computer program product for determining the need for requesting network configuration data from a network comprising computer program code, to make a computer execute, when said program code is loaded in the computer:

at least order the connection of said computer to a network,

compare first network identifying data associated with said network with second locally stored network identifying data, and

use locally stored network configuration data associated with said second network identifying data for obtaining services if said first network identifying data and said second network identifying data at least partially correspond to each other.

The present invention has the advantage of using previously known network configuration data of a network. In this way the amount of data transferred in the network is reduced. It is in many cases possible to immediately start using services provided in the network. This also leads to a low power consumption, which is an important feature for portable client devices that are often battery powered. The invention is furthermore automatic without requiring the involvement of a user. The invention is also cheap and simple to implement in a client device.

Claim 2 is directed towards performing a complete search in case a connected network does not match with stored network identification data. This has the advantage of only making searches if the network is unknown.

According to claim 3 network identity indicators are used. If a network has information that can be used for identifying it, this greatly simplifies the process of finding out if the network is known or not.

According to claim 4, liveness tests are made for network configuration data if this data has a certain age. This has the advantage of determining whether network configuration information is valid or not without performing a complete search.

Claim 5 is directed towards comparing the results of the liveness test with stored network configuration data and performing a new search if there are substantial differences. This has the advantage of updating the network configuration data if much of it is incorrect.

Claim 6 is directed towards searching for configuration data of the whole network in case the stored network identifying is truly outdated.

According to claim 7 a number of devices for which there is locally stored information are tried to be located in a connected network. This is a good way of identifying a network in case there does not exist a network identity indicator of the connected network.

According to claim 8 devices that are tried to be located are distinctive devices. This feature has the advantage of raising the probability of a correct network identification.

The general idea behind the invention is thus to connect a client device to a network and compare network identifying data that is associated with a network to which the client device is connected with network identifying data that is stored in the client device. The client device then uses locally stored network configuration data for obtaining services if the result of the comparison is at least a partial match. This allows avoiding of data transmission regarding network configuration for networks that are known to the client device.

These and other aspects of the invention will be apparent from and elucidated with reference to the embodiments described hereinafter.

The present invention will now be explained in more detail in relation to the enclosed drawings, where:

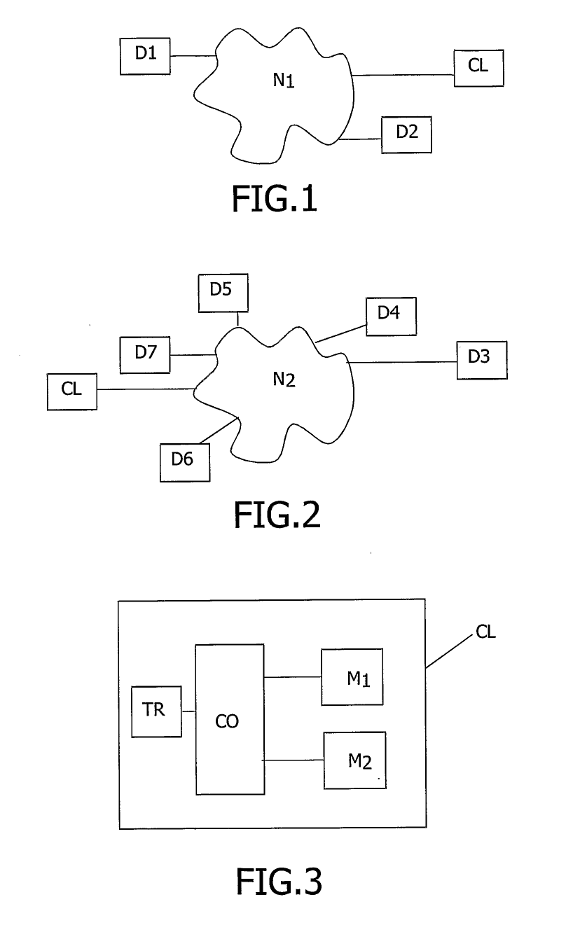

FIG. 1 shows a block schematic of a first type of network having a certain network identity to which a client device according to the present invention is connected,

FIG. 2 shows a block schematic of a second type of network lacking network identity to which a client device according to the present invention is connected,

FIG. 3 shows a block schematic of a client device according to the present invention,

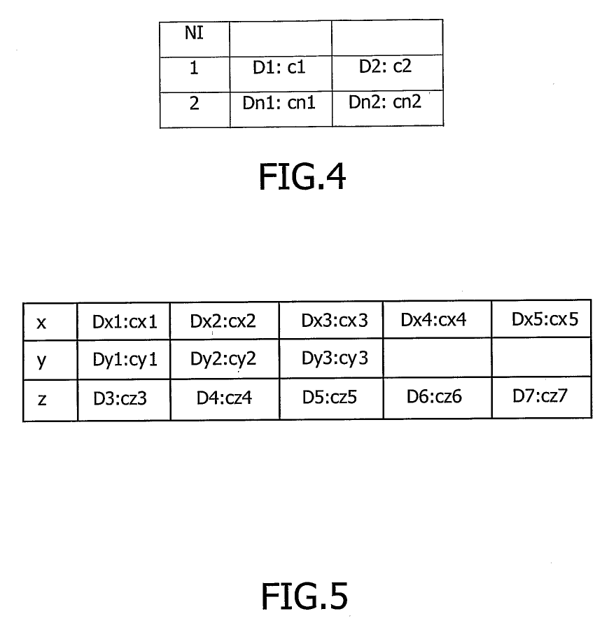

FIG. 4 shows a first table mapping different network configurations to corresponding network indicators for networks of the first type,

FIG. 5 shows a second table mapping different network configurations to corresponding imaginary network indicators for networks of the second type,

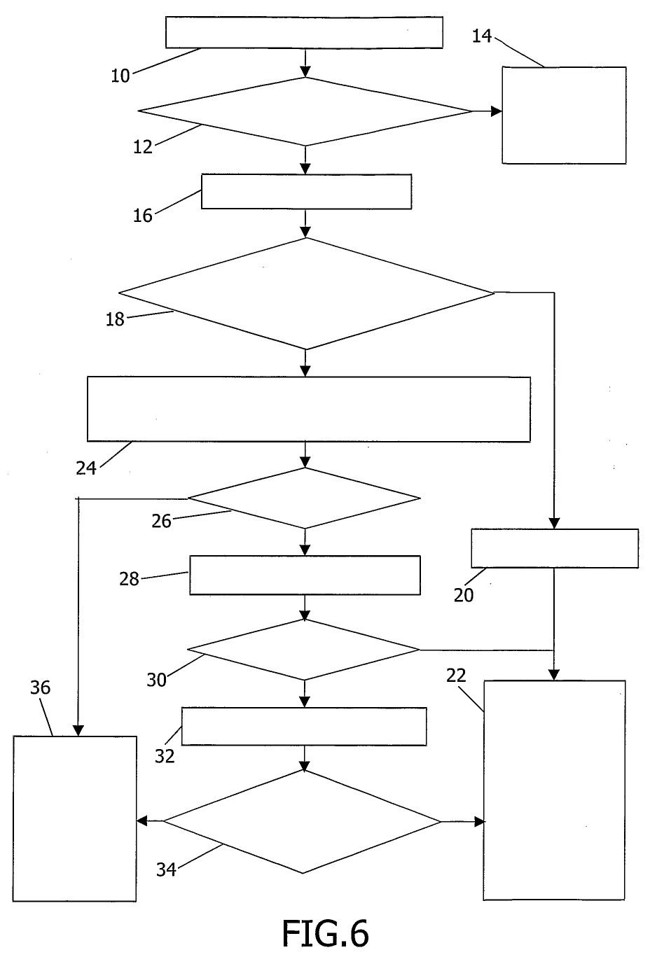

FIG. 6 shows a flow chart of a method of determining the need for requesting network configuration,

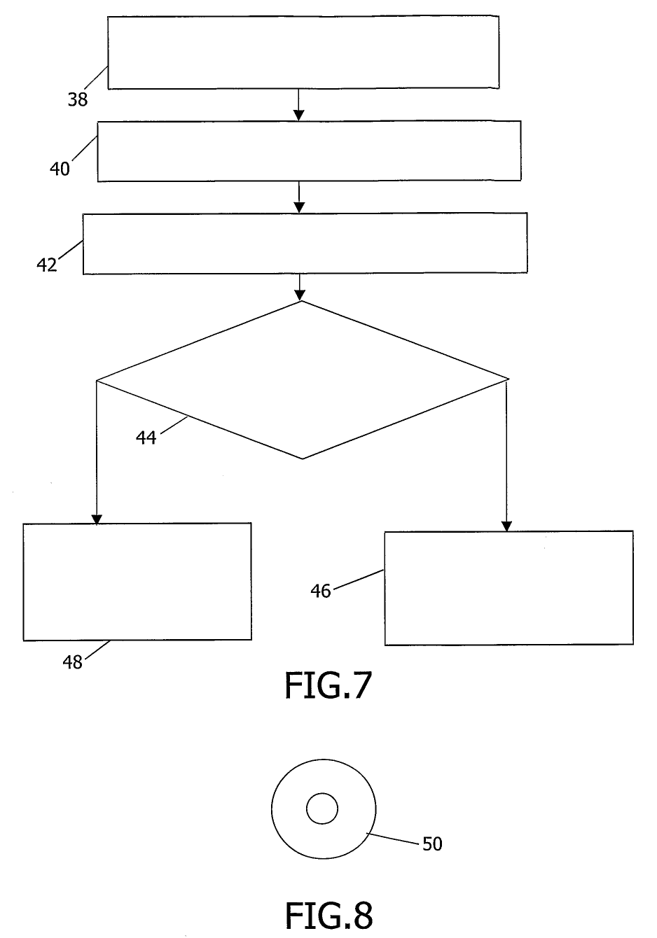

FIG. 7 shows a flow chart of a method of performing network estimation for a network of the second type, and

FIG. 8 shows a computer program product in the form of a CD ROM disc for storing of program code for performing the invention.

FIG. 1 shows a block schematic of a first computer network N₁ of a first type which has a network identity, to which a client device CL according to the present invention can be connected. The network N₁ is in one embodiment a home network allowing peer-to-peer networking, in which different services can be provided. Because of this the network N₁ includes a number of physical entities of which a first and a second device D1 and D2 are devices that provide different services like for instance MP3 player, web radio, DVD player etc. They can however also be other types of devices like an internet gateway or a printer. The client device, which is here connected to the network, accesses the services of the devices D1 and D2.

The network is preferably a wireless network, like for instance a wireless LAN network or a Bluetooth™ network, but is not limited to these and can also be a fixed network like a LAN network as well as a mixture with a wireless and a wired part. As was mentioned above, the peer-to-peer networking is here enabled by the UPnP™ standard but other ways of connecting are just as well applicable like SLP (Service Location Protocol) or Jini.

FIG. 2 shows a block schematic of the client device CL connected to a second network N₂ of a second type, which network lacks network identity. The network N₂ is a so-called ad-hoc network and includes devices D3, D4, D5, D6 and D7 as well as the client device CL. This network can be a Bluetooth™ network. Also here the client device CL accesses the services provided by the devices D3, D4, D5, D6 and D7.

FIG. 3 shows a block schematic of a client device CL according to an embodiment of the present invention. The device includes a control unit CO connected to a first memory M₁ provided for networks of the first type and a second memory M₂ provided for networks of the second type. The control unit CO is also connected to a transceiving unit TR for communicating with different networks. It should here be realized that the separation into different memories is provided for more clearly describing the present invention. It is also possible to provide just one memory for both network types.

As mentioned above the client device CL is in the described embodiment a mobile device and can therefore freely be moved between different networks, which might take place because a user of the device moves from for instance his home environment to his work, where different networks exist. The normal practice is then to make so-called searches each time the client device enters a network.

According to the UPnP™ standard it is customary for a client device to make a multicast search when it gets connected to a network in order to find out about the devices of the network and the configurations. This search is a so-called M-search, where an M-search has a number of fields, of which two are, MX and ST, where MX is maximum wait time and ST defines type of search, like a search for all devices, root devices, a particular device, any device of certain type and any service of a certain type. In such a search the client device will typically have the search made for all devices of the network, which search is thus a multicast search. Searches are described in more detail in UPnP™ Device Architecture, Version 1.0, 8 Jun. 2000, by UPnP Forum, which is herein incorporated by reference.

As has been mentioned before a client device can get disconnected several times and it would then, according to normal practice, make a new multicast search every time it reconnects to the network. This means that there is a lot of overhead or extra data transmitted in the network. This takes a lot of time and occupies bandwidth from better things like the transmission of multimedia data, especially if the client device knows about the network from previous experience. It would therefore be advantageous if this search overhead was reduced. The present invention is directed towards limiting the amount of searches made in case the client device has been connected to a network before. This is done by using a network identifying scheme according to the present invention.

According to the present invention, when the client device first enters a new network it identifies the network and makes a multicast search, i.e. a search for all devices and services in the network. A response here normally comprises data in the form of information about the location of the device, information about the service it provides as well as some indication of how long the service is available. In UPnP™ this information is provided in the form of Cache-Control information, location information and USN (Unique Service name) information. The identity of a network is in a wireless LAN network provided through an ESSID (Extended Service Set Identifier) or SSID (Service Set Identifier). ESSID and SSID are here associated with at least one access point of the network. If the network would include a server, the identity could as an alternative be associated with the server in question. In Ethernet this could be the MAC address of the DHCP (Dynamic Host Configuration Protocol) server and in Bluetooth™ the address of the master of the piconet. These are all examples of network identity indicators. In case the network does not have as network identity, i.e. is a so called ad-hoc network, the device sets an internal network identity indicator to the network in order to better locate the network in question in case it later gets connected to that particular network. The network identity is then stored together with the configuration information of the devices of the network. As is shown in FIGS. 4 and 5 the network identity indicators of networks having an identity are stored in memory M₁ and internal network identity indicators of networks lacking identity in memory M₂. The client device thus stores the configuration information and corresponding network identity indicator in a memory for every new network visited in order to facilitate later reconnection to these networks. As an example the client device CL has visited two networks having identity indicators 1 and 2, where the network having identity indicator 1 is the network of FIG. 1 including devices D1 and D2, having configurations c1 and c2, respectively, and the network having identity indicator 2 has devices Dn1 and Dn2 with configurations cn1 and cn2, respectively. The client device has likewise visited networks internally denoted x, y and z and lacking network identities, where network x is a network having devices Dx1, Dx2, Dx3, Dx4 and Dx5 with configurations cx1, cx2, cx3, cx4 and cx5. Network y is a network having devices Dy1, Dy2 and Dy3 with configurations cy1, cy2 and cy3 and network z is the network shown in FIG. 2 having devices D3, D4, D5, D6 and D7 having configurations cz1, cz2, cz3, cz4, cz5, cz6 and cz7. Normally each device has its own configuration. It should however be noted that some devices in a network might have the same configuration. It is also possible that some devices are the same in two networks, like a device that is present in two networks at the same time, say for instance devices Dx5 and D5 in networks x and z.

Now that the environment in which the invention is provided has been described, a method of determining the need for requesting network configuration information provided in the client device CL will first be described with reference being made to above mentioned FIGS. 1, 3, 4 and 6, where the latter shows a flow chart of the method of determining the need for requesting configuration data. The client device CL first connects to a network, step 10, which as an example is the network N₁ in FIG. 1. The connection is carried out by the transceiving unit TR under the control of the control unit CU. Upon connecting to the network the control unit CO orders the transceiving unit TR to try to obtain first network identifying data in the form of the network identity indicator. If there is no network identity indicator NI, step 12, the control unit CO of the client device CL goes on and performs network estimation, step 14. How network estimation is performed will be described later on. If however there is a network identity indicator NI, step 12, the transceiving unit TR then receives the network identity indicator, step 16, which is in this embodiment received from the access point. The network identity indicator NI is then forwarded to the control unit CO. The control unit CO thereafter compares the received network identity indicator NI with second network identifying data in the form of locally stored network identity indicators in the memory M₁, step 18. If there is no such network identity indicator NI in the memory M₁, the control unit CO stores the received network identity indicator NI, step 20, and orders the transceiving unit TR to perform a multicast search. This search is a query regarding the configuration of the network. The received results of the search are then stored by the control unit CO in the memory M₁ together with the previously received network identity indicator. It thus stores the received network identity indicator NI together with information of the devices in the network and their configurations, step 22. If there is such a network identity indicator in the memory M₁, step 18, the control units proceeds to step 24.

In the present example, the client device CL received identity number 1, which it had stored in memory M₁. In step 24 control unit CO thereafter compares the storage time ST of the network configuration data of all devices of the identified network N₁, i.e. devices D1 and D2, with a first threshold value T1, step 24. The test is made if there is doubt about the correctness of the configuration data or about the presence of a device in the network. If the comparison indicates that the storage time ST is shorter than a time indicated by the first threshold value T1, step 26, the locally stored network configuration data can be used, i.e. the client device can directly use the services provided by devices D1 and D2 of the network N₁, step 36. If however the storage time ST was longer than the time indicated by the threshold value T1, step 26, the control unit CO goes on and compares the storage time ST with a second threshold value T2, step 28, which represents a longer time. If the storage time was longer than the time indicated by the second threshold value T2, step 30, the control unit CO proceeds with ordering the transceiving unit TR to perform a multicast search and then stores the results together with the associated network identity NI, step 22. This is done when the stored network configuration data is truly outdated. If the storage time was shorter than the time indicated by the second threshold value T2, step 30, the control unit CO goes on and orders the transceiving unit TR to perform a liveness test of the devices in the network, step 32.

A liveness test is according to this embodiment of the invention done by performing unicast searches directed to the devices in the network. In the M search command, the ST (search target) field is here set to contain the universally unique identifier of the device in question. The MX field is furthermore set to a minimum so that there will be no delay in the response from the devices that are being checked regarding liveness. Such a search is then sent to each device in the network. There is thus one message for each device being checked. It is furthermore possible that a device may ignore the MX field and therefore also speed up the response. Thereafter the control unit CO goes on and compares the results of the liveness tests with the stored configuration information and if there were no substantial differences, the client device CL can then directly use the network configuration data network, step 36. If however there were substantial differences, step 34, the control unit CL orders the transceiving unit TR to perform a multicast search and then stores the results of the search associating them with the current network identity indicator, step 22. The different method steps of FIG. 6 are outlined in table I below.

TABLE I

| | |
|---|---|
| 10 | CONNECT TO NETWORK |
| 12 | DOES NI EXIST |
| 14 | PERFORM NETWORK ESTIMATION |
| 16 | RECEIVE NI |
| 18 | CORRESPONDING NI IN M₁ ? |
| 20 | STORE NEW NI |
| 22 | PERFORM MULTICAST SEARCH AND STORE RESULTS |
| | ASSOCIATED WITH NI |
| 24 | COMPARE STORAGE TIME ST OF LOCALLY STORED |
| | NETWORK CONFIGURATION DATA WITH T1 |
| 26 | ST > T1 ? |
| 28 | COMPARE ST WITH T2 |
| 30 | ST > T2 ? |
| 32 | PERFORM LIVENESS TEST |
| 34 | SUBSTANTIAL DIFFERENCES ? |
| 36 | NETWORK READY FOR USE |

When a network is ready for use it is possible for the control unit of the client device to present the devices to a user via a user interface and present the possibility to search for new devices as well as the possibility to allow direct use of services associated with the devices.

Now a description will follow of how to handle networks having no network identity indicator, where these networks are so-called ad-hoc networks. This will now be explained with reference being made to FIGS. 2, 3, 5 and 7, where the latter shows a flow chart of a method of performing network estimation. The client device CL has thus here already connected to the network, tried to locate a network identity indicator and failed to obtain it. When this is the case the control unit CO first retrieves locally stored information about the most recently visited networks lacking network identities from the second memory M₂, step 38. It then selects a subset of the devices in each stored network, step 40, where the subset are made up of devices that are distinctive and have a high probability of being present in a network. Such a subset is here denoted locally stored second network identifying data. A distinctive device is here a device that has been noted to be present in only one network. A device having a high probability is a device that has been noted to be present for a long time in a network. In order to simplify the network estimation it would suffice to only check for one distinctive device in order to identify the network in question. From FIG. 5 it can be seen that devices Dx1, Dy1 and D6 are distinctive in networks x, y, z. The control unit CO then orders the transceiving unit TR to check the presence of the selected devices in the connected network, step 42. This is done by sending unicast searches directed towards the selected devices, which may thus be only one device. By doing this the second network identifying data is compared with first network identifying data, where said first network identifying data is information of located devices in the second network N₂. This is then done for all the networks and the control unit CO then selects the best matching network, i.e. information of a network in the second memory M₂ that has the most matches. This is a network that has at least a partial matching of the selected devices. The control unit CO then compares the number of devices of this best matching network with a third threshold T3, and if the number of devices of the best matching network is below the third threshold T3, step 44, the control unit CO orders the transceiving unit TR to perform a multicast search and stores the result as configuration information about a new network in the second memory M₂, step 48. If however the number of devices are above the third threshold T3 the best matching network is selected as the network the client device CL is connected to, step 46. If only one device was checked this threshold T3 could then be set to one. Thereafter liveness tests can be performed in dependence of the first and second threshold just as in the case of a network having a network identity indicator and the network configuration data of the network be used directly. In the present example the control unit CO could for instance check if devices D6, Dx1 and Dy1 were present in the network N₂. Since device D6 was present, it would then select network z as connected network.

The method steps of the network estimation method are outlined in table II below.

TABLE II

| | |
|---|---|
| 38 | RETRIEVE INFORMATION OF MOST RECENT VISITED |
| | NETWORKS LACKING NI |
| 40 | SELECT DEVICES THAT ARE DISTINCTIVE AND HAVE HIGH |
| | PROBABILITY OF BEING PRESENT |
| 42 | CHECK PRESENCE OF SELECTED DEVICES IN CONNECTED |
| | NETWORK |
| 44 | NO. OF DEVICES OF BEST MATCHING NETWORK BELOW |
| | T3 ? |
| 46 | SELECT BEST MATCHING NETWORK AS CONNECTED |
| | NETWORK |
| 48 | PERFORM MULTICAST SEARCH AND STORE AS NEW |
| | NETWORK |

By performing searches in this way, only when it is necessary, the amount of data transferred is reduced. The client device can furthermore in many cases immediately start using the services provided in the network if it is known. Complete searches are only made when they are actually needed, like if the network is new or the configuration data is outdated. The amount of communication performed by the client device is thus lowered, which leads to a lower power consumption. This is an important feature for portable devices that are often battery powered. The invention is furthermore automatic without requiring the involvement of a user. The invention is cheap and simple to implement in a client device.

There are a number of variations that can be made to the present invention. The determination of the need for a liveness test can be made on a device by device basis. The determination need furthermore not be made solely based on the storage time but can be based also on other parameters, like type of device and the history of the device, i.e. if it has a history of being moved between networks. It is furthermore possible to disregard some types of devices. The network estimation can, as was mentioned before, be limited to checking only one distinctive device. It is furthermore possible to provide a method only for networks having an identifier or for networks lacking an identifier. Liveness tests can furthermore be combined with searches for new devices. Another possible variation is to provide a liveness test of only some devices, like the most relevant ones. A search used in a liveness test could furthermore be a search directed towards more than one device. Another variation is to omit the liveness test completely. Also the test if the configuration data is outdated might be omitted. Also the network estimation might be varied. It is for instance possible to stop testing network configuration data when a match has been found.

If a network furthermore has as directory server that keeps track of all network configuration changes it is possible to combine the present invention with sending a specialized query to that server regarding network changes since the last time the client device visited the network in question. As a response the client device would then receive the difference in configuration of the devices between the two points in time. This allows a further reduction of the search overhead.

The invention can be implemented in any suitable form including hardware, software, firmware or combinations of these. However, preferably, the invention is implemented as computer software stored in a program memory and run on one or more data processors and/or digital signal processors. The program code can also be provided on a computer program product, of which one is shown in FIG. 8 in the form of a CD ROM disc 50. This is just an example and various other types of computer program products are just as well feasible like memory sticks. The computer program product can also be provided in pure program code that can be downloaded for instance from a further server, perhaps via the Internet. The elements and components of an embodiment of the invention may be physically, functionally and logically implemented in any suitable way. Indeed the functionality may be implemented in a single unit, in a plurality of units or may be physically and functionally distributed between different units and processors.

Although the present invention has been described in connection with a specific embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally although individual features may be included in different claims, these may possibly be advantageously combined and the inclusion in different claims does not imply that a combination of features is not feasible and/or advantageous. In addition singular references do not exclude a plurality. Thus references to “a”, “an”, “first”, “second” etc. do not preclude a plurality. Reference signs in the claims are provided merely as a clarifying example and shall not be construed as limiting the scope of the claims in any way.

1. Method of requesting network configuration information from a network (N₁, N₂) comprising the steps of:
coupling a client device (CL) to a network, (step 10),
comparing first network identifying data associated with said network with second locally stored network identifying data, (step 18; 42), and
using locally stored network configuration data associated with said second network identifying data for obtaining services if said first network identifying data and said second network identifying data at least partially correspond to each other (step 36).

2. Method according to claim 1, further comprising the step of sending at least one query about the configuration of the network, (step 22), if the compared first and second network identifying data do not correspond to each other.

3. Method according to claim 1, further comprising the step of receiving said first network identifying data in the form of a network identity indicator (NI) from said network (N₁), (step 16), wherein the step of comparing comprises comparing said first network identity indicator with a second locally stored network identity indicator and the step of using is performed if they match each other.

4. Method according to claim 1, further comprising the steps of:
comparing the time (ST) (locally stored network configuration data, which is associated with successfully compared second network identifying data, has been stored) with a first threshold (T1), (step 24),
performing a liveness test on devices indicated in the configuration data if said threshold is exceeded, (step 32), and
otherwise performing the step of using locally stored network configuration data for obtaining services (step 36).

5. Method according to claim 4, further comprising the steps of:
comparing the results of the liveness test with said locally stored configuration data, and
sending at least one query about the configuration of the network (step 22) if the results of the liveness test shows considerable differences from the locally stored configuration data associated with the second network identifying data, (step 34).

6. Method according to claim 4, further comprising the step of comparing, if the first threshold is exceeded, the time locally stored configuration data, which is associated with successfully compared second network identifying data, has been stored with a second threshold (T2), (step 28), and sending at least one query about the configuration of the network if the second threshold is exceeded.

7. Method according to claim 1, further comprising the step of selecting locally stored information about a number of devices in a network, (step 40), wherein the step of comparing comprises trying to locate, in the connected network, the devices indicated in said selected locally stored information, (step 42), and the step of using locally stored network configuration data is performed if at least some of said devices are located in the network.

8. Method according to claim 7, wherein the step of selecting comprises selecting at least one distinctive device that is likely to be present in a network.

9. Method according to claim 7, wherein there is locally stored information about a number of networks and further performing the steps of selecting and comparing for at least some of these networks and selecting the best matching information about devices in a network as data identifying the connected network.

10. Method according to claim 9, further comprising the steps of comparing the matching of the best matching network with a third threshold (T3), (step 44), and selecting the network as connected network if the threshold is exceeded, (step 46), and otherwise sending at least one query about the configuration of the connected network, (step 48).

11. Client device (CL) for determining the need for requesting network configuration information from a network (N₁, N₂) and comprising:
at least one memory (M₁, M₂) comprising network identifying data (NI) and corresponding configuration data, and
a control unit (CO) arranged to:
at least order the connection of said client device to a network,
compare first network identifying data associated with said network with second locally stored network identifying data from said memory, and
use locally stored network configuration data associated with said second network identifying data for obtaining services if said first network identifying data and said second network identifying data at least partially correspond to each other.

12. Computer program product (50) for determining the need for requesting network configuration information from a network (N₁, N₂), comprising computer program code, to make a computer execute, when said program code is loaded in the computer:
at least order the connection of said computer to a network,
compare first network identifying data associated with said network with second locally stored network identifying data, and
use locally stored network configuration data associated with said second network identifying data for obtaining services if said first network identifying data and said second network identifying data at least partially correspond to each other.
